(19) United States
(12) Patent Application Publication
(10) Pub. No.: US 2007/0152908 A1
(43) Pub. Date: Jul. 5, 2007

(54) Adaptive image block fusion

(76) Inventors: Mionul H. Khan, Austin, TX (US); Bradley C. Aldrich, Austin, TX (US)

Correspondence Address: BUCKLEY, MASCHOFF & TALWALKAR LLC, 50 LOCUST AVENUE, NEW CANAAN, CT, 06840, US

(21) Appl. No.: 11/322,921

(22) Filed: Dec. 30, 2005

(51) Int. Cl. G09G 1/10

(52) U.S. Cl. 345/16

(57) ABSTRACT

According to some embodiments, motion vector information associated with a set of image blocks is tracked. The tracked information may include motion vector information associated with subsets of the image blocks, and at least some of the subsets may be of different sizes. At least one subset of image blocks may then be adaptively fused into a single image block.

### BACKGROUND

An image encoder may encode image information to reduce the amount of data needed to represent the image. For example, a media encoder might encode locally stored image information and transmit the encoded information to another device, which in turn can decode the information and present the image to a user (e.g., a video phone might transmit a stream that includes image frames to another video phone through a wireless network).

In some encoding protocols, an image being encoded is divided into smaller image portions, such as macroblocks and blocks, so that information encoded with respect to one image portion does not need to be repeated with respect to another image portion (e.g., because neighboring or prior image portions may have similar motion characteristics). Moreover, images may be divided into portions of different sizes. For example, it may be more efficient to encode one frame into squares of 16×16 picture elements while 4×4 picture element squares might be more important for another frame. Note that image information might be encoded using different sized portions within a single frame.

Using larger image portions may help reduce the amount of information needed to represent the image. Depending on the image, however, too large of an image portion might reduce the quality of the decoded image. To determine which sizes are most appropriate and efficient for an image, the data may be encoded multiple times (and different size assumptions might be made during each pass through the encoding process). The different results may then be evaluated to select the proper size blocks for the image. Such an approach, however, may be inefficient and consume an impractical amount of power (especially for a small mobile device).

### BRIEF DESCRIPTION OF THE DRAWINGS

FIG. 1 is a block diagram of an image block encoding apparatus according to some embodiments.

FIG. 2 is a flow diagram illustrating an image block encoding method according to some embodiments.

FIG. 3 is a block diagram of a portion of a motion vector information tracker according to some embodiments.

FIG. 4 is a block diagram of another portion of a motion vector information tracker according to some embodiments.

FIG. 5 illustrates threshold testing for block fusion according to some embodiments.

FIG. 6 is a block diagram of a block size selector according to some embodiments.

FIG. 7 is a block diagram of a first level block fusion decision according to some embodiments.

FIG. 8 is a block diagram of a second level block fusion decision according to some embodiments.

FIG. 9 is a block diagram of a system according to some embodiments.

### DETAILED DESCRIPTION

An image encoder may reduce the amount of data that is used to represent image content before the data is stored and/or transmitted as a stream of image information. As used herein, information may be encoded and/or decoded in accordance with any of a number of different protocols. For example, image information may be processed in connection with International Telecommunication Union-Telecommunications Standardization Sector (ITU-T) recommendation H.264 entitled “Advanced Video Coding for Generic Audiovisual Services” (2004) or the International Organization for Standardization (ISO)/International Engineering Consortium (IEC) Motion Picture Experts Group (MPEG) standard entitled “Advanced Video Coding (Part 10)” (2004). As other examples, image information may be processed in accordance with ISO/IEC document number 14496 entitled “MPEG-4 Information Technology-Coding of Audio-Visual Objects” (2001) or the MPEG2 protocol as defined by ISO/IEC document number 13818-1 entitled “Information Technology-Generic Coding of Moving Pictures and Associated Audio Information” (2000). As other examples, the image information might comprise Microsoft Windows Media Video 9 (MSWMV9) information or Society of Motion Picture and Television Engineers (SMPTE) Video Codec-1 (VC-1) information. Some examples of devices that might incorporate an image encoder include video phones, video conferencing devices, and Voice Over Internet Protocol (VoIP) devices.

In some encoding protocols, an image being encoded is divided into smaller image portions, such as macroblocks and blocks, so that information encoded with respect to one image portion does not need to be repeated with respect to another image portion (e.g., because neighboring or prior image portions may have similar motion characteristics). Moreover, images may be divided into portions of different sizes. For example, it may be more efficient to encode one frame into squares of 16×16 picture elements while 4×4 picture element squares might be more important for another frame. Note that an image might be encoded using different sized portions within a single frame.

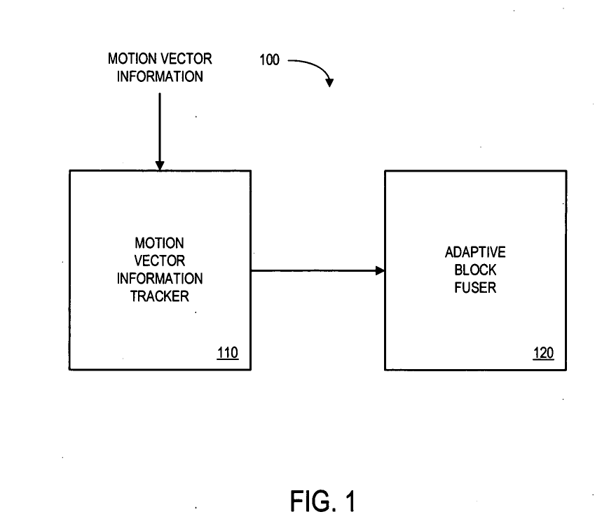

To determine which sizes are most appropriate when encoding an image, FIG. 1 is a block diagram of an image block encoding apparatus 100 according to some embodiments. The apparatus 100 might be associated with any type of image encoder, including a video phone, a video conferencing device, a personal image recorder, a personal image transmitter, a portable device, and/or a wireless device.

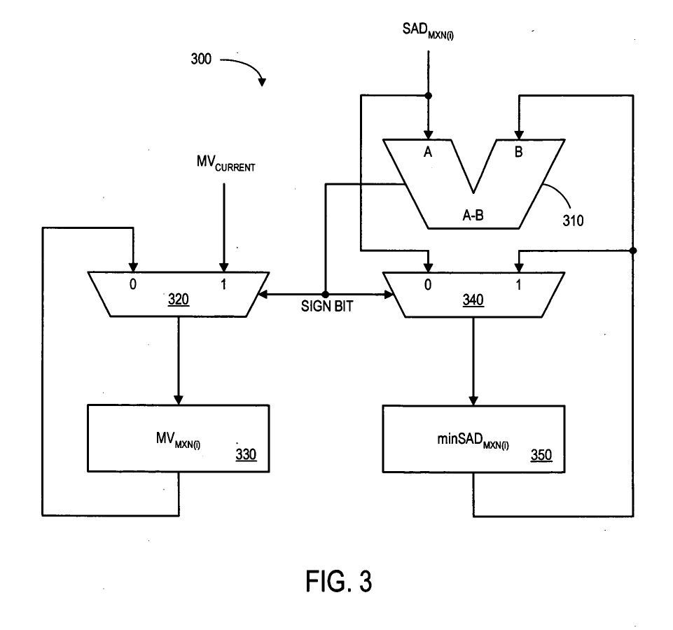

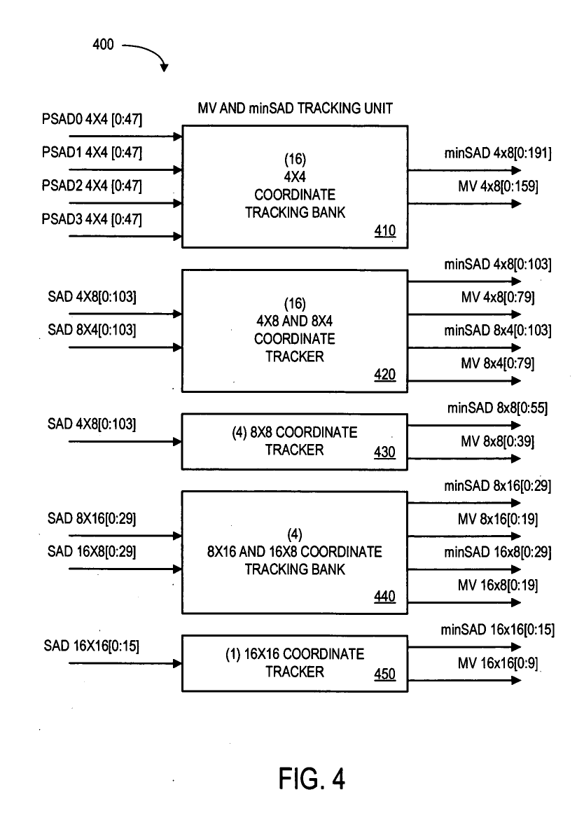

The apparatus 100 includes a motion vector information tracker 110 to receive and store information associated with motions vectors. By way of example only, the motion vector information tracker 110 might include registers that store information representing Sum of Absolute Difference (SAD) values associated with motion vectors. The SAD values might, for example, indicate how closely an area of a current image frame matches an area of a previous image frame. Examples of a motion vector information tracker 110 according to some embodiments are described with respect to FIGS. 3 and 4.

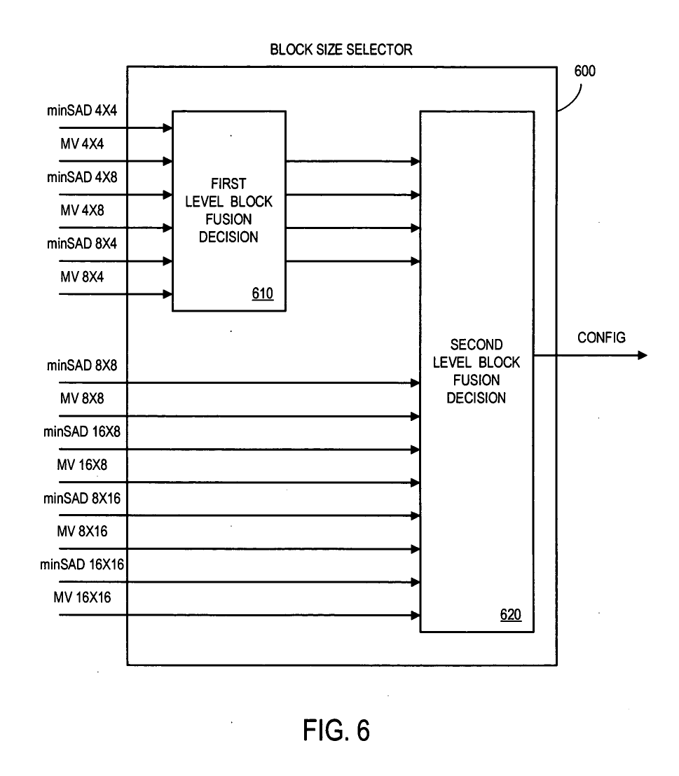

The apparatus 100 also includes an adaptive block fuser 120 to dynamically select an image block configuration based on the information stored sum in the motion vector information tracker 110. The configuration selection may be “dynamic” in that it can change as an image is being encoded. Examples of an adaptive block fuser 120 according to some embodiments are described with respect to FIGS. 6 through 8.

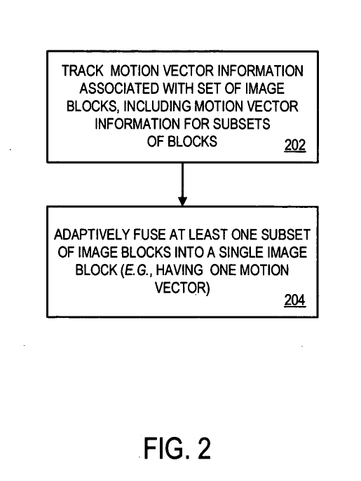

FIG. 2 is a flow diagram illustrating an image block encoding method according to some embodiments. The method may be performed, for example, by the image block encoding apparatus 100 of FIG. 1. The flow chart describe herein does not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 202, motion vector information associated with a set of image blocks is tracked, including motion vector information associated with subsets of the image blocks. Moreover, note that at least some of the subsets may be of different sizes. By way of example only, the motion vector information might be associated with SAD values or SAD value minimums.

At 204, at least one subset of image blocks is adaptively fused into a single image block. According to some embodiments, further processing may be performed to determine if the fused image block should again be fused with another image block (e.g., another fused image block). The resulting block may then be encoded using a single motion vector (and thus reduce the amount of information needed to represent the original image).

Some examples will now be provided with respect to H.264 image information. Note, however, that embodiments may be implemented using other types of image information. Using H.264 encoding, a display image may be divided into an array of “macroblocks.” Each macroblock might represent, for example, a 16×16 set of picture samples or pixels.

H.264 permits variable block-size selection at encode time (in particular, blocks of the following sizes may be selected: 16×16, 8×8, 16×8, 8×16, 4×8, 8×4, 4×4).

FIG. 3 is a block diagram of a portion of a motion vector information tracker 300 according to some embodiments. In particular, the tracker 300 is to determine and store (1) the minimum SAD value and (2) the coordinate where that minimum SAD value occurred.

The tracker 300 includes a difference element 310 that receives the current SAD value (SAD_{MXM(i)}) for a particular 4×4 image block along with the lowest SAD value previously encountered (minSAD_{MXM(I)} stored in a minimum SAD value register 350). The difference 310 outputs a sign bit indicate which of the two values is larger. When minSAD_{MXM(i)} is larger than the current SAD_{MXM(i)}, the value of SAD_{MXM(i)} is moved into the minimum SAD value register 350 via a multiplexer 340 and the current motion vector coordinate (MV_{CURRET}) is moved into a coordinate register 330 via another multiplexer 320.

The tracker 300 illustrated in FIG. 3 stores the SAD minimum value and associated coordinate associated with a single motion vector. Note, however, embodiments may concurrently keep track of multiple motion vectors. Consider, for example, an embodiment that can break down a 16×16 block into various combinations with a 4×4 block resolution. In this case, the embodiment may track 41 motion vectors (16 associated with 4×4 blocks, 4 associated with 8×8 blocks, 1 associated with a 16×16 block, 2 associated with 16×8 blocks, 2 associated with 8×16 blocks, 8 associated 8×4 blocks, and 8 associated with 4×8 blocks). During motion estimation, for every 4×4 SAD value computed can be used for 1 of 41 motion vector computations. A set of 41 SAD value registers, previously found min SAD value registers 350 and corresponding motion vector coordinate registers 330 may be thus be created (each corresponding to one of the block sizes) as illustrated by the tracking unit 400 of FIG. 4.

The tracking unit 400 may include a 4×4 coordinate tracking bank 410 that includes 16 trackers as described with respect to FIG. 3. The tracking unit 400 also includes a 4×8 and 8×4 coordinate tracker 420 (including 8 4×8 trackers and 8 8×4 trackers for a total of 16 trackers). The tracking unit 400 may further include an 8×8 coordinate tracker 430, an 8×16 and 16×8 coordinate tracking bank 440, and a 16×6 coordinate tracker 450. According to some embodiments, the tracking unit 400 is implemented using an array of SAD engines, where SAD values are computed at a granularity not-higher than a 4×4 block.

Note that a single 16×16 macro-block can be decomposed in approximately 1,600 ways using seven different blocks sizes. In order to choose an appropriate rate-distortion combination adaptive block fusion may be used to select the right block combination. The block fusion approach may find the largest block possible to describe the motion, thus reducing number of motion vectors to be encoded.

According to some embodiments, an adaptive algorithm measures co-directionality of adjacent motion vectors. If the direction and magnitude of neighboring motion vectors are similar, the corresponding sub-blocks are fused into one block. Co-directionality may be measured, for example, using a threshold. In this case, two motion vectors may co-directional if the difference of the x-axis components and the y-axis components are below the threshold. Note that in a motion estimation array, both the motion vector and residuals for all the block sizes may be tracked, and, as a result various algorithms can be adopted in a user-programmable manner without significantly increasing any implementation complexity.

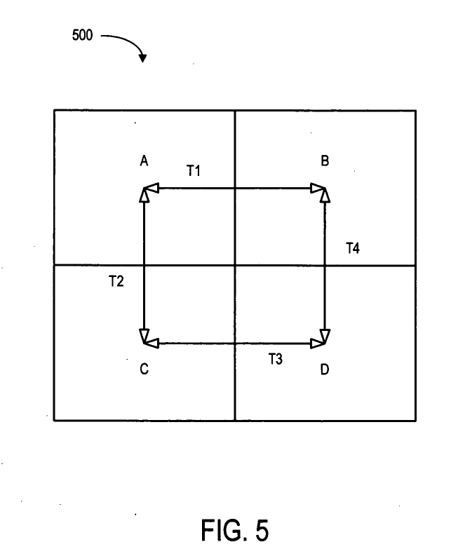

For example, FIG. 5 illustrates threshold testing 500 for block fusion according to some embodiments. In this case, 4 neighboring blocks of the same size (e.g., 4×4 or 8×8) are labeled A, B, C, and D. Moreover, a threshold value of “T1” will be used to determine whether the motion vector associated with block A is similar enough to block B such that A and B should be fused into a single block (denoted (A, B) herein). Similarly, threshold values T2, T3, and T4 determine whether or not (A, C), (C, D), (D, B) should be fused.

Each of the threshold conditions might be measured in any number of ways. Threshold condition T1 for example, might be computed by comparing a difference between a pair of x-axis motion vector components with an x-axis threshold value, comparing a difference between a pair of y-axis motion vector components with an y-axis threshold value, and then determining to fuse the adjacent image blocks when both comparisons indicate that the difference was below the associated threshold value. In other words, a motion vector difference based fusion approach might be defined as:
T₁::|MV_{A}−MV_{B}|≦Th::|MV_{A}^{X}−MV_{B}^{X}|+|MV_{A}^{Y}−MV_{B}^{Y}|≦Th

Where MV_{A}^{X} and MV_{A}^{Y} refer to the x and y component of the motion vector for block A, respectively.

According to another embodiment, a modified motion vector difference based fusion approach may be used:
T₁::|MV_{A}−MV_{AB}|+|MV_{B}−MV_{AB}|≦Th::
|MV_{A}^{X}−MV_{AB}^{X}|+|MV_{A}^{Y}−|MV_{AB}^{Y}|+|MV_{B}^{X}−MV_{AB}^{X}|+|MV_{B}^{Y}−MV_{AB}^{Y}≦Th

Where MV_{AB}^{X} and MV_{AB}^{Y} refer to the x and y component of the motion vector for fused block (block A and block B being fused), respectively.

According to yet another embodiment, a motion vector difference and distortion based fusion approach may be employed:
T₁::|MV_{A}−MV_{AB}|+|MV_{B}−MV_{AB}|≦Th_{MV}·═SAD_{AB}−SAD_{A}−SAD_{B}|≦Th_{SAD}

Where SAD_{AB} refers to the SAD value of the block comparison for fused block (A, B) corresponding to the motion vector MV_{AB}.

According any embodiment, a threshold value Th might be fixed or programmed by a user or controller. For example, a threshold values might be programmed by tan application. Note that a rate control algorithm, scene content, and/or other information might alter the threshold value selection.

Note that the concurrent coordinate tracker and adaptive block fusion combined may choose appropriate block-sizes (hence coding efficiency) without having to take multiple passes of the data (motion estimation for different block sizes).

FIG. 6 is a block diagram of a block size selector 600 according to some embodiments. The block size selector 600 may, for example, receive information from a motion vector information tracker 110 and, based on the received information, make a first level blocking decision 610. For example, the first level blocking decision 610 might indicate that two 4×4 blocks should be fused into a single 4×8 block. A second level block fusion decision 620 may then be made. For example, the second level block fusion decision 620 might indicate that an 8×8 block should be fused with a 4×8 block made by the first level block fusion decision 610.

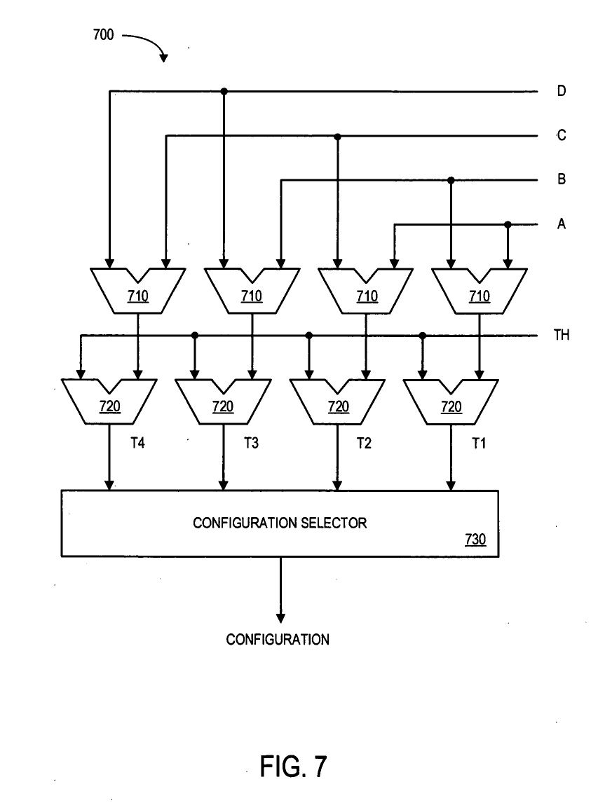

FIG. 7 is a block diagram of a first level block fusion decision circuit 700 according to some embodiments. The circuit 700 includes a first set of difference generators 710 to generate differences between neighboring vector component values. For example, the right most difference generator 710 in FIG. 7 generates the difference between the A and B components. A second set of difference generators 720, each to generate a difference between an output of the first set of difference generators 710 and a threshold value Th. For example, the right most difference generator 720 in FIG. 7 generates the difference between (A−B) and TH. Note that the generators 710, 720 might be associated with, for example, a sum of absolute differences engine, an Arithmetic Logic Unit (ALU), and/or a programmable hardware resource.

A configuration selector 730 may receive the outputs from the second set of difference generators 720 (T1 through T4) and provide an indication of image block configuration. Table I illustrates how the configuration selector 730 might operate according to some embodiments.

TABLE I
First Level Configuration Selection

| | | | | | | | Number |
|---|---|---|---|---|---|---|---|
| | | | | | | | of |
| | | | | | | | Motion |
| | Configuration | Condition (AND) | | | | Notes | Vectors |
| 0 | A, B, C, D | T1 | T2 | T3 | T4 | No blocks fused | 4 |
| 1 | (A, C), B, D | T1 | T2 | T3 | T4 | 1 pair of blocks fused | 3 |
| 2 | (A, C), (B, D) | T1 | T2 | T3 | T4 | 2 pairs of blocks fused | 2 |
| 3 | A, C, (B, D) | T1 | T2 | T3 | T4 | 1 pair of blocks fused | 3 |
| 4 | (A, B), C, D | T1 | T2 | T3 | T4 | 1 pair of blocks fused | 3 |
| 5 | (A, B), (C, D) | T1 | T2 | T3 | T4 | 2 pairs of blocks fused | 2 |
| 6 | A, B, (C, D) | T1 | T2 | T3 | T4 | 1 pair of blocks fused | 3 |
| 7 | (A, B, C, D) | T1 | T2 | T3 | T4 | All blocks fused | 1 |

Thus, in the first stage of the processing four neighboring 4×4 blocks can be compared and eight outcomes are possible (labeled entries 0 through 7 in Table I): in one case all blocks are fused, in one case no blocks are fused, in four cases one block pair is fused, and in two cases two block pairs are fused.

In Table I, Tx shows the threshold condition is true and Tx represents that the threshold condition is not valid. The outcome of each quadrant of the macros block (each 8×8 portion of a 16×16 block) is referred to herein as Ca, Cb, Cc, and Cd.

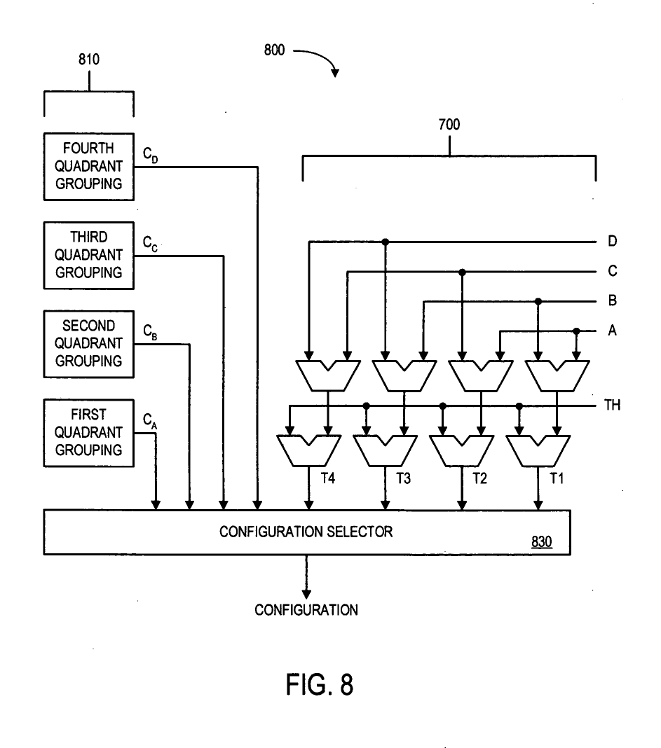

FIG. 8 is a block diagram of a second level block fusion decision 800 according to some embodiments. As before, the output of the first level block fusion decision circuit 700 is provided to a configuration selector 830. In this case, however, the configuration selector 830 further receives grouping information 810 about each of the four quadrants (e.g., such that the subsets may be further grouped).

Table II illustrates how the configuration selector 830 might operate according to some embodiments.

TABLE II
Second Level Configuration Selection

| | | Condition for | | | | | | | | Number of |
|---|---|---|---|---|---|---|---|---|---|---|
| | | current level of | | | | Condition from Prior level of | | | | Motion |
| | | hierarchy | | | | Hierarchy | | | | Vectors |
| 0 | A, B, C, D | T1 | T2 | T3 | T4 | Ca != 7 | Cb != 7 | Cc != 7 | Cd != 7 | 4-16 |
| 1 | (A, C), B, D | T1 | T2 | T3 | T4 | Ca == 7 | Cb != 7 | Cc == 7 | Cd != 7 | 3-9 |
| 2 | (A, C), (B, D) | T1 | T2 | T3 | T4 | Ca == 7 | Cb == 7 | Cc == 7 | Cd == 7 | 2 |
| 3 | A, C, (B, D) | T1 | T2 | T3 | T4 | Ca != 7 | Cb == 7 | Cc != 7 | Cd == 7 | 3-9 |
| 4 | (A, B), C, D | T1 | T2 | T3 | T4 | Ca == 7 | Cb == 7 | Cc != 7 | Cd != 7 | 3-9 |
| 5 | (A, B), (C, D) | T1 | T2 | T3 | T4 | Ca == 7 | Cb == 7 | Cc == 7 | Cd == 7 | 2 |
| 6 | A, B, (C, D) | T1 | T2 | T3 | T4 | Ca != 7 | Cb != 7 | Cc == 7 | Cd == 7 | 3-9 |
| 7 | (A, B, C, D) | T1 | T2 | T3 | T4 | Ca == 7 | Cb == 7 | Cc == 7 | Cd == 7 | 1 |

In this table, Tx refers to the threshold condition is true for the 4-8×8 neighboring blocks and Tx refers the condition to be false. Ca, Cb, Cc, Cd refer to the configurations (0-7) from the 1st stage. Moreover, “==” indicates the values are equal and “!=” indicates that the values are not equal. Note that in some cases, a second level of fusing might be performed by running an output from a resource back through that same resource.

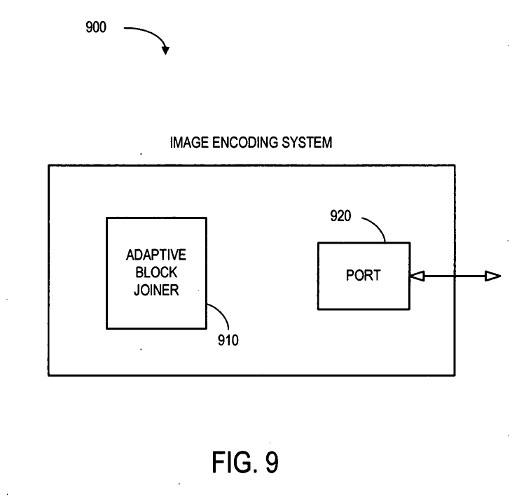

FIG. 9 is a block diagram of a system 900 according to some embodiments. The system 900 might be associated with, for example, a video phone or conferencing device. The system 900 includes an adaptive block joiner 910 according to any of the embodiments described herein. The adaptive block joiner 910 may, for example, dynamically select an image block configuration based on stored motion vector information (and, in some cases, multi-level block joining may be performed). The system 900 further includes a digital output port 920 to provide a digital signal to another device (e.g., via a wireless connection).

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although particular image processing protocols and networks have been used herein as examples (e.g., H.264), embodiments may be used in connection any other type of image processing protocols or networks, such as Digital Terrestrial Television Broadcasting (DTTB) and Community Access Television (CATV) systems. Note that any of the embodiments described herein might be associated with, for example, an Application Specific integrated Circuit (ASIC) device, a processor, or an image encoder.

The several embodiments described herein are solely for the purpose of illustration. Persons skilled in the art will recognize from this description other embodiments may be practiced with modifications and alterations limited only by the claims.

What is claimed is:

1. A method, comprising:
tracking motion vector information associated with a set of image blocks, including motion vector information associated with subsets of the image blocks, at least some of the subsets being of different sizes; and
adaptively fusing at least one subset of image blocks into a single image block.

2. The method of claim 1, further comprising:
encoding the fused image block using a single motion vector.

3. The method of claim 1, wherein the motion vector information includes at least one of: (i) sum of absolute difference values, or (ii) sum of absolute difference value minimums.

4. The method of claim 1, further comprising for a pair of adjacent image blocks:
comparing a difference between a pair of x-axis motion vector components with an x-axis threshold value;
comparing a difference between a pair of y-axis motion vector components with an y-axis threshold value; and
determining to fuse the adjacent image blocks when both comparisons indicate that the difference was below the associated threshold value.

5. The method of claim 1, wherein said fusing comprises at least one of: (i) motion vector difference based fusion, (ii) modified motion vector based fusion, or (iii) motion vector difference and distortion based fusion.

6. The method of claim 1, further comprising:
fusing the fused image block with another image block.

7. The method of claim 1, wherein the image block is associated with at least one of: (i) H.264 information, (ii) Motion Picture Experts Group 2 information, or (iii) Motion Picture Experts Group 4 information.

8. An apparatus, comprising:
a motion vector information tracker to store sum of absolute difference value minimums; and
an adaptive block fuser to dynamically select an image block configuration based on the stored sum of absolute difference value minimums.

9. The apparatus of claim 8, wherein the motion vector information tracker includes:
registers to concurrently track sum of absolute difference value minimums associated with a plurality of motion vectors.

10. The apparatus of claim 8, wherein the adaptive block fuser includes:
a first set of difference generators to generate differences between neighboring vector component values.

11. The apparatus of claim 10, wherein the adaptive block fuser further includes:
a second set of difference generators, each to generate a difference between an output of the first set of difference generators and a threshold value.

12. The apparatus of claim 11, wherein the adaptive block fuser further includes:
a configuration selector to receive the outputs from the second set of difference generators and to provide an indication of image block configuration.

13. The apparatus of claim 12, wherein the configuration selector is to further receive subset grouping information.

14. The apparatus of claim 11 wherein at least one of the first and second sets of difference generators are associated with at least one of: (i) a sum of absolute differences engine, (ii) an arithmetic logic unit, or (iii) a programmable hardware resource.

15. The apparatus of claim 8, wherein the apparatus is associated with at least one of: (i) a video phone, (ii) a video conferencing device, (iii) a personal image recorder, (iv) a personal image transmitter, (v) a portable device, or (vi) a wireless device.

16. An apparatus comprising:
a storage medium having stored thereon instructions that when executed by a machine result in the following:
determining that a first subset of image blocks should be combined in a single image block based on motion vector information associated with the image blocks in the first subset; and
determining if the combined image block should be further combined with additional image blocks; and
encoding the combined image block using a single motion vector.

17. The apparatus of claim 16, wherein determining that the first subset should be combined is associated with at least one of: (i) motion vector difference based fusion, (ii) modified motion vector based fusion, or (iii) motion vector difference and distortion based fusion.

18. The apparatus of claim 16, wherein determining that the first subset should be combined is associated with a programmable threshold value.

19. The apparatus of claim 18, wherein the threshold value is dynamically determined.

20. A system, comprising:
an adaptive block joiner to dynamically select an image block configuration based on stored sum of absolute difference value minimums; and
a digital output to provide a digital signal to another device.

21. The system of claim 20, wherein the adaptive block joiner is to perform multi-level block joining.

22. The system of claim 21, wherein the multi-level block joining is performed by running an output from a resource back through the resource.
